(19) United States
(12) Patent Application Publication
(10) Pub. No.: US 2019/0367038 A1
(43) Pub. Date: Dec. 5, 2019

(54) DRIVER MONITORING DEVICE

(71) Applicant: SHARP KABUSHIKI KAISHA, Osaka (JP)

(72) Inventor: MASAYUKI FUKUMI, Sakai City (JP)

(21) Appl. No.: 16/399,150

(22) Filed: Apr. 30, 2019

Related U.S. Application Data
(60) Provisional application No. 62/680,085, filed on Jun. 4, 2018.

(51) Int. Cl. B60W 40/09; G06K 9/00; B60W 50/14

(52) U.S. Cl. CPC B60W 40/09; G06K 9/00845; B60W 2050/146; B60W 2050/143; B60W 50/14

(57) ABSTRACT

A driver monitoring device is provided with a driver monitoring camera that takes an image of a face of a driver, a detection unit that detects safety check action information related to a safety check action of the driver on the basis of a face image of the driver captured by the driver monitoring camera, and a determination unit that determines whether or not the driver is neglecting the safety check action on the basis of the safety check action information detected by the detection unit.

### TECHNICAL FIELD

The present invention relates to a driver monitoring device that urges a driver to perform safety check actions during the travel of a moving object such as a vehicle.

### BACKGROUND ART

For example, close to 90% of traffic accidents are caused by human driving error. Among these, the greatest factor is thought to be the neglect of safety check actions due to dangerous driving behaviors such as distracted driving and drowsy driving, insufficient experience of the driver, lowered attentiveness (carelessness), and the like. To reduce such human driving error, driver monitoring devices have come to be known in recent years, in which the driver's face is captured by an imaging device such as an onboard camera, and on the basis of the captured image, face information such as the direction of the driver's face and the opening degree of the eyelids is detected, such that in the case of determining that the driver is performing a dangerous driving behavior such as distracted driving or drowsy driving, a warning is issued to urge the driver to avoid the dangerous driving behavior.

For example, Japanese Unexamined Patent Application Publication No. 2011-43961 discloses a driver monitoring device that determines whether or not a driver is drowsy on the basis of the closed state of the driver's eyelids. Also, Japanese Unexamined Patent Application Publication No. 2010-23626 discloses a driver monitoring system that enables favorable monitoring of drowsiness and distraction of the driver by attaining improved accuracy in feature point detection of the driver's face.

However, the above technologies of the related art are effective at restraining human driving error due to dangerous driving behaviors such as distracted driving and drowsy driving of the driver, but are not effective with regard to human driving error due to the neglect of safety check actions caused by insufficient experience of the driver, lowered attentiveness, and the like.

Accordingly, an objective of the present invention is to provide a driver monitoring device capable of reducing human driving error due to the neglect of safety check actions caused by insufficient experience of the driver, lowered attentiveness, and the like.

### SUMMARY OF INVENTION

(1) One embodiment of the present invention is a driver monitoring device provided with a driver monitoring camera that takes an image of a face of a driver, a detection unit that detects safety check action information related to a safety check action of the driver on the basis of a face image of the driver captured by the driver monitoring camera, and a determination unit that determines whether or not the driver is neglecting the safety check action on the basis of the safety check action information detected by the detection unit.

(2) Also, in addition to the configuration of (1) above, an embodiment of the present invention additionally is provided with a light source that radiates infrared rays toward the face of the driver, wherein the driver monitoring camera takes an image of the face of the driver irradiated by the infrared rays from the light source.

(3) Also, in addition to the configuration of (1) above or the configuration of (2) above, in an embodiment of the present invention, the safety check action information includes information computed from a direction of the face and/or a direction of a line of sight.

(4) Also, in addition to the configuration of any one of the configurations (1) to (3) above, in an embodiment of the present invention, the determination by the determination unit of whether or not the safety check action is neglected is performed at at least one time from among when turning left or turning right, when changing lanes, and when starting moving.

(5) Also, in addition to the configuration of any one of the configurations (1) to (4) above, in an embodiment of the present invention, the determination unit determines that the safety check action is neglected in the case in which the safety check action is not performed from a start time of an operation of a direction indicator until a direction of a steering wheel changes by a certain angle or more.

(6) Also, in addition to the configuration of any one of the configurations (1) to (5) above, in an embodiment of the present invention, the safety check action includes at least one safety check action from among a safety check action using a rear-view mirror, a safety check action using a side mirror, and a direct visual safety check action.

(7) Also, in addition to the configuration of any one of the configurations (1) to (6) above, in an embodiment of the present invention, in a case in which the determination unit determines that the driver is neglecting the safety check action, a warning is issued to the driver.

(8) Also, in addition to the configuration of (7) above, in an embodiment of the present invention, the warning is issued by sound.

(9) Also, in addition to the configuration of (7) above or the configuration of (8) above, in an embodiment of the present invention, the warning is issued by light.

(10) Also, in addition to the configuration of any one of the configurations (1) to (9) above, in an embodiment of the present invention, a purpose of driver monitoring is switched in accordance with an operation of a direction indicator.

(11) Also, in addition to the configuration of any one of the configurations (1) to (10) above, in an embodiment of the present invention, while a direction indicator is operating, a warning informing the driver that one is engaged in dangerous driving behavior is not issued.

(12) Another embodiment of the present invention is a driver monitoring device provided with a driver monitoring camera that takes an image of a face of a driver, a detection unit that detects dangerous driving behavior information related to a dangerous driving behavior of the driver on a basis of a face image of the driver captured by the driver monitoring camera, and a determination unit that determines whether or not the driver is engaged in the dangerous driving behavior on a basis of the dangerous driving behavior information detected by the detection unit, wherein while a direction indicator is operating, a warning informing the driver that one is engaged in dangerous driving behavior is not issued.

According to the present invention, it becomes possible to reduce human driving error due to the neglect of safety check error caused by insufficient experience of the driver, lowered attentiveness, and the like.

### BRIEF DESCRIPTION OF DRAWINGS

FIG. 1 is a system configuration diagram illustrating a schematic configuration of a driver monitoring device.

FIG. 2 is a schematic diagram illustrating how the driver monitoring device is installed onboard a vehicle.

FIG. 3 is a schematic diagram illustrating safety check actions when turning left or changing to a lane on the left side.

FIG. 4 is a schematic diagram illustrating safety check actions when turning right or changing to a lane on the right side.

FIG. 5A is a flowchart illustrating an example of a process when a direction indicator is not operating in the driver monitoring device.

FIG. 5B is a flowchart illustrating an example of a process when a direction indicator is operating in the driver monitoring device.

FIG. 6 is an explanatory diagram for explaining a person's pupil and a Purkinje image.

FIG. 7 is an explanatory diagram for explaining the positional relationship between a person's pupil and a Purkinje image.

FIG. 8 is a graph illustrating the change over time in a count of the neglect of safety check actions and a count of dangerous driving behaviors while driving.

### DESCRIPTION OF EMBODIMENTS

Hereinafter, embodiments according to the present invention will be described with reference to the drawings. In the following description, the same components are denoted with the same signs. The same also applies to names and functions. Consequently, detailed descriptions of these will not be repeated. Note that each diagram is a simplified diagram for the purpose of understanding the present invention, and the safety check actions and the installation positions and number of installations of the driver monitoring camera 21, the light source 22, and the like are merely examples. Also, the embodiments are described by taking a vehicle with the steering wheel on the right as an example, but the same also applies to vehicles with the steering wheel on the left.

### Embodiment 1

(Driver Monitoring Device)

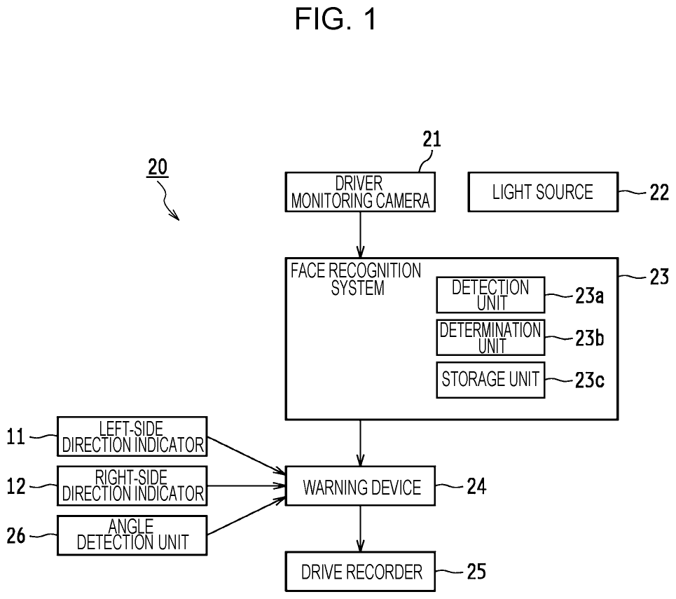

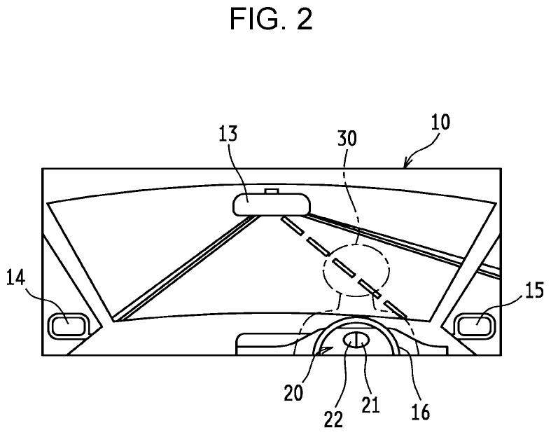

First, a schematic configuration of a driver monitoring device 20 will be described while referring to FIGS. 1 and 2.

FIG. 1 is a system configuration diagram illustrating a schematic configuration of a driver monitoring device 20, and FIG. 2 is a schematic diagram illustrating how the driver monitoring device 20 is installed onboard a vehicle 10.

The driver monitoring device 20 is provided with a driver monitoring camera 21 and a face recognition system 23, and constitutes a driver monitoring system. The face recognition system 23 includes a detection unit 23a, a determination unit 23b, and a storage unit 23c.

The driver monitoring camera 21 is installed onboard the vehicle 10 and takes an image of the face of a driver 30 who drives the vehicle 10. The detection unit 23a detects safety check action information related to safety check actions of the driver 30 on the basis of a face image of the driver 30 captured by the driver monitoring camera 21. The determination unit 23b determines whether or not the driver 30 is neglecting safety check actions on the basis of the safety check action information detected by the detection unit 23a. Herein, insufficient experience, lowered attentiveness (carelessness), and the like are given as examples of the causes of the neglect of the safety check operations by the driver 30.

The driver monitoring camera 21 is an imaging device that includes an imaging element such as a CMOS image sensor. The onboard position of the driver monitoring camera 21 is exemplified by a position where it is possible to capture an image of the face of the driver 30, such as the top part of the cluster or steering column, or the A pillar.

According to the driver monitoring device 20, safety check action information is detected by the detection unit 23a on the basis of a face image of the driver 30 captured by he driver monitoring camera 21, and whether or not the driver 30 is neglecting safety check actions is determined by the determination unit 23b on the basis of the safety check action information detected by the detection unit 23a. With this arrangement, human driving error due to the neglect of safety check actions caused by insufficient experience, lowered attentiveness, and the like of the driver 30 may be reduced.

In the present embodiment, the driver monitoring device 20 is additionally provided with a light source 22 that radiates infrared rays toward the face of the driver 30. The driver monitoring camera 21 takes an image of the face of the driver 30 irradiated with infrared rays from the light source 22. Also, to capture only the region illuminated by the infrared rays radiated from the light source 22, the driver monitoring camera 21 is provided with a bandpass filter that passes only specific wavelengths, and the specific wavelength are decided in accordance with the wavelengths radiated from the light source 22. With this arrangement, the influence of ambient light such as sunlight may be decreased. Moreover, since infrared rays have wavelengths which are not recognizable by human eyes, the driver 30 does not perceive glare even when infrared rays are radiated toward the face of the driver 30. Consequently, the above may avoid influencing driving, and is effective. As the infrared rays, it is preferable to use near-infrared rays (for example, near-infrared rays having a peak wavelength approximately from 700 nm to 2500 nm). Likewise, the light source 22 may be disposed at the position where it is possible to radiate infrared rays toward the face of the driver 30, such as the top part of the cluster or steering column, or the A pillar, similarly to the driver monitoring camera 21. In this example, a light source that emits near-infrared rays (wavelength 940 nm) as the light source 22.

In the present embodiment, the safety check action information includes information computed from the direction of the face and/or the direction of the line of sight (the direction of the eyeball). In other words, the detection unit 23a computes the direction of the face and/or the direction of the line of sight of the driver 30 on the basis of the face image of the driver 30 captured by the driver monitoring camera 21. With this arrangement, the detection unit 23a is able to compute the safety check action information easily.

In the present embodiment, the determination by the determination unit 23b of whether or not safety check actions are being neglected is performed at at least one time from among when the vehicle 10 turns left or turns right, changes lane, and starts moving. With this arrangement, it is possible to monitor the presence or absence of safety check actions at at least one time from among when turning left or turning right, changing lanes, and starting moving.

The driver monitoring device 20 additionally is provided with an angle detection unit 26. In this example, the angle detection unit 26 is a steering angle measuring instrument that detects the direction (operating angle) of the steering wheel 16 provided in the vehicle 10. Since a conventionally known device may be used as the steering angle measuring instrument, a detailed description is omitted here.

In the present embodiment, the determination unit 23b determines that a safety check action is neglected in the case in which a safety check action is not performed from the start time of an operation of a direction indicator 11 or 12 provided ie the vehicle 10 until the direction (operating angle) of the steering wheel 16 detected by the angle detection unit 26 changes by a certain predetermined angle (for example, 20°) or more. With this arrangement, the presence or absence of safety check actions may be determined reliably.

In the present embodiment, the safety check actions include at least one safety check action from among a safety check action using a rear-view mirror 13, safety check actions using side mirrors 14 and 15, and a direct visual safety check action. With this arrangement, the presence or absence of a safety check action may be determined at an appropriate time.

In the present embodiment, the driver monitoring device 20 is additionally provided with a warning device 24. In the case in which the determination unit 23b determines that the driver 30 is neglecting safety check actions, a warning informing the driver 30 that one is neglecting safety check actions is issued by the warning device 24. With this arrangement, it is possible to inform the driver 30 that one is neglecting safety check actions, and thereby reliably reduce human driving error due to the neglect of safety check actions caused by insufficient experience, lowered attentiveness, and the like of the driver 30.

Specifically, as illustrated in FIG. 1, the driver monitoring device 20 uses the face recognition system 23 to acquire a face image of the driver 30 captured by the driver monitoring system 21, analyzes the direction (orientation) of the face and/or the line of sight (gaze), and in the case of determining that the driver 30 is neglecting safe driving behavior because of insufficient experience, lowered attentiveness, or the like, causes the warning device 24 to produce a warning corresponding to the situation. With this arrangement, the neglect of safe driving behavior may be avoided.

During normal travel [such as moving forward, with the direction indicators 11 and 12 in a stopped state (off state)], the detection unit 23a detects dangerous driving behavior information related to dangerous driving behavior of the driver 30 on the basis of the face image of the driver 30 captured by the driver monitoring camera 21. Herein, examples of dangerous driving behaviors include drowsy driving, distracted driving, and the like. The determination unit 23b determines whether or not the driver 30 is engaged in dangerous driving behavior on the basis of the dangerous driving behavior information detected by the detection unit 23a. With this arrangement, human driving error due to dangerous driving behaviors such as drowsy driving and distracted driving by the driver 30 may be reduced.

In the present embodiment, in the case of determining that the driver 30 is engaged in dangerous driving behavior, the determination unit 23b causes the warning device 24 to issue a warning informing the driver 30 that one is engaging in dangerous driving behavior. With this arrangement, it is possible to inform the driver 30 that one is engaging in dangerous driving behavior, and thereby reliably reduce human driving error due to dangerous driving behaviors such as drowsy driving and distracted driving by the driver 30.

In the present embodiment, the warning is issued with sound (for example, speech) and/or light. With this arrangement, in the case of issuing a warning informing the driver that one is neglecting safe driving behavior and additionally informing the driver 30 that one is engaging in dangerous driving behavior, it is possible to reliably inform the driver that one is engaging in driving behavior dangerous driving behavior.

Regarding a warning issued by sound, a warning is issued using an electronic sound, or depending on the situation, with a speech message such as “Wake up.”, “Keep your eyes on the road.”, “Check your safety.”, or “Be alert.”. Also, regarding a warning issued by light, a warning is issued by emitting light that blinks, turns on, or a combination thereof at the driver 30 from a light emitter such as an LED. With this arrangement, it is possible to urge the driver 30 to avoid the neglect of safety check actions caused by insufficient experience, lowered attentiveness, or the like, and furthermore avoid dangerous driving behaviors such as distracted driving and drowsy driving.

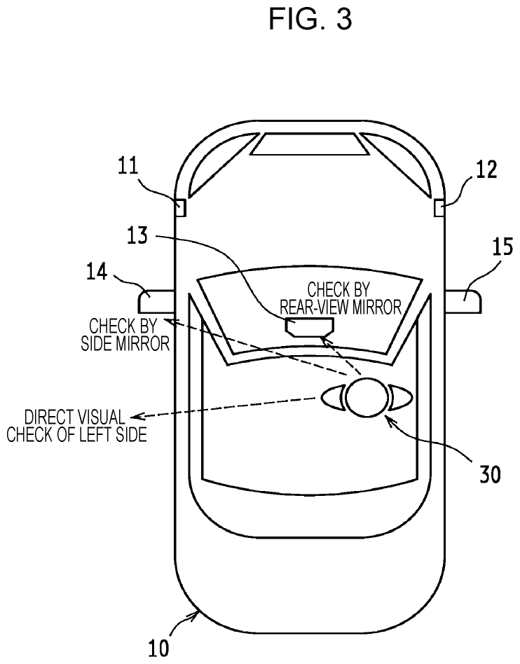

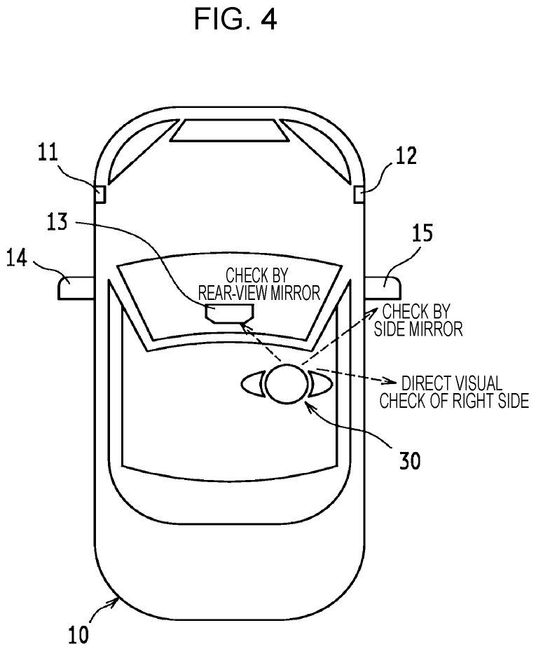

FIG. 3 is a schematic diagram illustrating safety check actions when turning left or changing to a lane on the left side, and additionally, FIG. 4 as a schematic diagram illustrating safety check actions when turning right or changing to a lane on the right side.

In the present embodiment, the driver monitoring device 20 switches the purpose of driver monitoring according to the operation of the direction indicators 11 and 12 provided in the vehicle 10. With this arrangement, it is possible to switch the purpose of driver monitoring in accordance with the operation of the direction indicators 11 and 12.

Specifically, the driver monitoring device 20 switches the purpose of driver monitoring between monitoring the presence or absence of dangerous driving behaviors such as distracted driving or drowsy driving by the driver 30, and monitoring the presence or absence of safety check actions caused by insufficient experience, lowered attentiveness, or the like of the driver 30. Regarding the mode whereby the purpose of driver monitoring is switched, in a state in which the direction indicators 11 and 12 are not operating, the presence or absence of dangerous driving behaviors may be monitored, and when the direction indicator 11 or 12 operates, the mode may switch from monitoring the presence or absence of dangerous driving behaviors to monitoring the presence or absence of safety check actions, whereas when the direction indicator 11 or 12 ceases to operate, the mode may switch from monitoring the presence or absence of safety check actions to monitoring the presence or absence of dangerous driving behaviors.

Incidentally, in the case of performing safety check actions when turning left or turning right or when changing lanes, such actions are misrecoghized as dangerous driving behaviors such as distracted driving.

Given this point, in the present embodiment, while the direction indicator 11 or 12 provided in the vehicle 10 is operating, the driver monitoring device 20 does not issue a warning informing the driver 30 that one is engaging in dangerous driving behaviors such as distracted driving. With this arrangement, in the case of performing safety check actions when turning left or turning right or when changing lanes, it is possible to avoid misrecognizing such actions as dangerous driving behaviors such as distracted driving.

Also, while the vehicle is traveling, the driver monitoring device 20 analyzes the opening degree of the eyelids and/or the direction (orientation) of the face of the driver 30, and in the case of determining that the driver 30 is engaging in dangerous driving behaviors such as distracted driving or drowsy driving, causes the warning device 24 to produce a warning corresponding to the situation. With this arrangement, danger may be avoided.

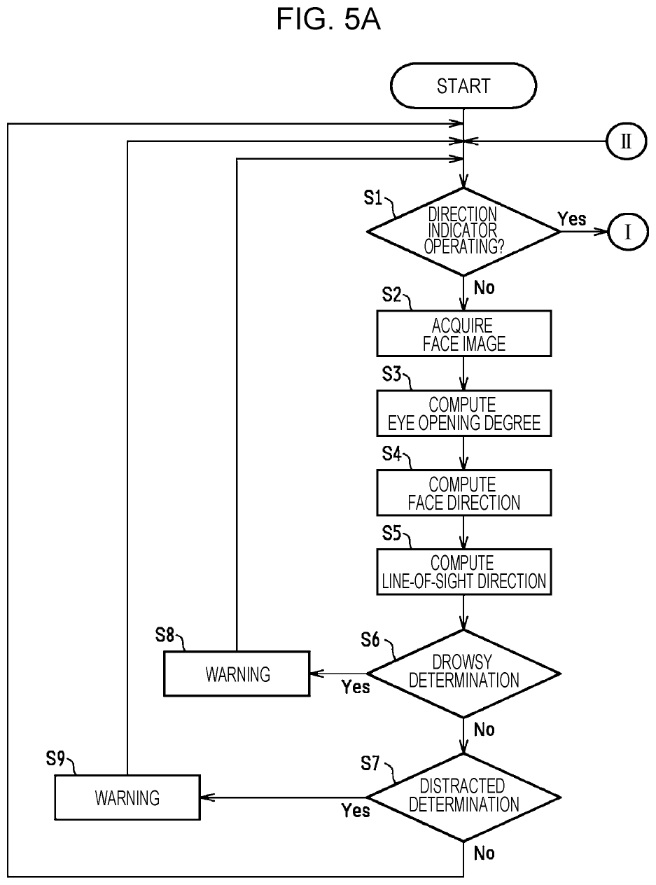

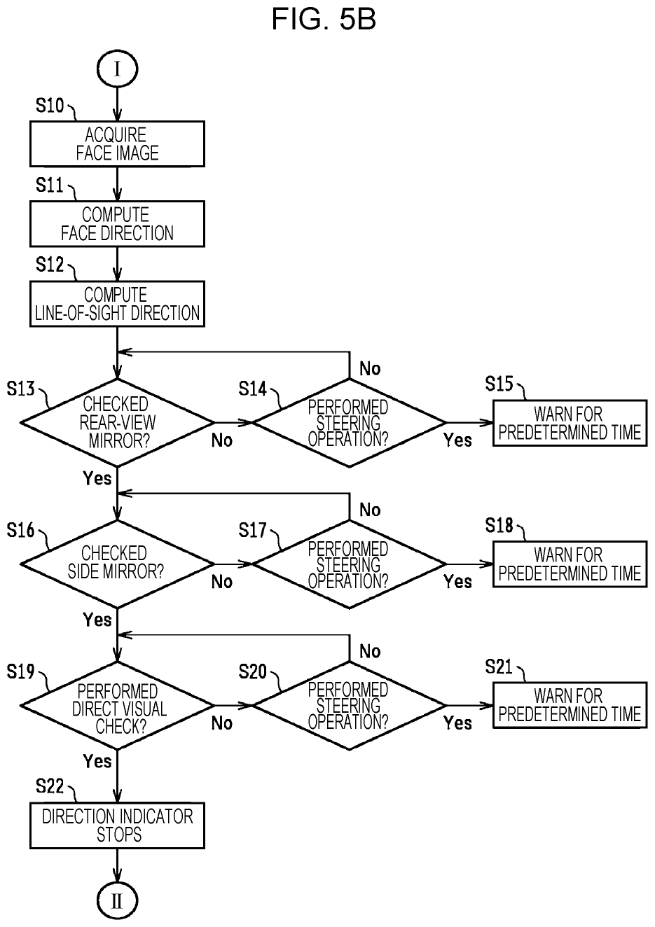

Next, a process of the driver monitoring device 20 according to the present embodiment will be described while referring to FIGS. 5A and 5B.

FIG. 5A is a flowchart illustrating an example of a process when the direction indicator 11 or 12 is not operating in the driver monitoring device 20, and FIG. 5B is a flowchart illustrating an example of a process when the direction indicator 11 or 12 is operating in the driver monitoring device 20.

As illustrated in FIG. 5A, the driver monitoring device 20 determines whether or not the direction indicator 11 or 12 is operating (S1), and in the case of determining that the direction indicators 11 and 12 are not operating (S1: No), the detection unit 23a acquires a face image of the driver 30 captured by the driver monitoring camera 21 (S2). Next, the detection unit 23a computes the opening degree of the eyes of the driver 30 (S3), computes the direction of the face (S4), and computes the direction of the line of sight (S5) on the basis of the face image of the driver 30. Next, the detection unit 23b determines whether or not the driver 30 is drowsy (S6).

In the case of determining that the driver 30 is drowsy (S6: Yes), the determination unit 23b causes the warning device 24 to produce a warning indicating that the driver 30 is drowsy (S8), and the flow proceeds to S1. On the other hand, in the case in which the determination unit 23b determines that the driver 30 is not drowsy (S6: No), the flow proceeds to S7. Next, the determination unit 23b determines whether or not the driver 30 is distracted (S7), and in the case of determining that the driver 30 is distracted (S7: Yes), causes the warning device 24 to produce a warning indicating that the driver 30 is distracted (S9), and the flow proceeds to S1. On the other hand, in the case in which the determination unit 23b determines that the driver 30 is not distracted (S7: No), the flow proceeds to S1. With this arrangement, it is possible to urge the driver 30 to avoid dangerous driving behavior.

On the other hand, when proceeding from normal travel to turning left, turning right, or changing lanes, the direction indicator 11 on the left side or the right side is made to operate. With this arrangement, it is possible to switch the purpose of driver monitoring from monitoring the presence or absence of dangerous driving behaviors such as distracted driving or drowsy driving by the driver 30 to monitoring the presence or absence of safety check actions caused by insufficient experience, lowered attentiveness, or the like of the driver 30.

Next, the determination by the determination unit 23b of the neglect of safety check actions will be described while referring to FIGS. 5B, 3, and 4.

Generally, as illustrated in FIG. 3, the recommended procedure for safe action when making a left turn is to cause the direction indicator 11 on the left side of the vehicle 10 to operate, check behind with the rear-view mirror 13, check behind on the left side of the vehicle 10 with the side mirror 14 on the left side, and additionally, after performing a direct visual check of the left side of the vehicle 10, perform the left turn. When this series of safety check actions is not performed, the warning device 24 is made to warn the driver with sound (for example, speech) and/or light. With this arrangement, it is possible to urge the driver to perform safety check actions.

On the other hand, as illustrated in FIG. 4, the recommended procedure for safe action when making a right turn is to cause the direction indicator 12 on the right side of the vehicle 10 to operate, check behind with the rear-view mirror 13, check behind on the right side of the vehicle 10 with the side mirror 15 on the right side, and additionally, after performing a direct visual check of the right side of the vehicle 10, perform the right turn. When this series of safety check actions is not performed, the warning device 24 is made to warn the driver with sound (for example, speech) and/or light. With this arrangement, it is possible to urge the driver to perform safety check actions.

As illustrated in FIG. 5A, in the case in which the driver monitoring device 20 determines that the direction indicator 11 on the left side or 12 on the right side is operating (S1: Yes), as illustrated in FIG. 5B, the detection unit 23a acquires a face image of the driver 30 captured by the driver monitoring camera 21 (S10). Next, the detection unit 23a computes the direction of the face of the driver 30 on the basis of the face image of the driver 30 (S11), and computes the direction of the line of sight (S12). Next, the determination unit 23b determines whether or not the driver 30 directs the line of sight toward the rear-view mirror 13 to perform a safety check (S13).

In the case of determining that the driver 30 has not performed a safety check with the rear-view mirror 13 (S13: No), the determination unit 23b determines whether or not the steering wheel 16 is operated (S14). In the case of determining that the steering wheel 16 is operated (S14: Yes), the determination unit 23b recognizes that a safety check action using the rear-view mirror 13 has not been performed, and causes the warning device 24 to warn the driver 30 with sound (for example, speech) and/or light that the driver did not perform a safety check using the rear-view mirror 13 (S15). With this arrangement, it is possible to urge the driver to perform a safety check action using the rear-view mirror 13. At this point, in the determination of the operation of the steering wheel 16, it is determined that the steering wheel 16 is operated in the case in which the steering wheel 16 turns to the left or to the right by 20° or more. With this arrangement, it is possible to avoid misrecognition due to slight wobbling of the steering wheel 16. Also, when causing the warning device 24 to issue a warning, the determination unit 23b sets the warning device 24 to stop the warning after a certain amount of time (for example, several seconds). With this arrangement, it is possible to effectively prevent the warning device 24 from continuing to issue the warning by sound (for example, speech) and/or light until a left turn, right turn, or lane change is completed and the direction indicator 11 on the left side or 12 on the right side stops. The same also applies to the case of checking the side mirrors and performing a direct visual check described later.

In the case in which the determination unit 23b determines that the driver 30 has performed a safety check using the rear-view mirror 13 (S13: Yes), next, the determination unit 23b determines whether or not the driver 30 checks behind on the left side or behind on the right side of the vehicle 10 with the side mirror 14 on the left side or 15 on the right side (S16).

In the case of determining that the driver 30 has not performed a safety check using the side mirror 14 on the left side or 15 on the right side (S16: No), the determination unit 23b determines whether or not the steering wheel 16 is operated (S17). In the case of determining that the steering wheel is operated (S17: Yes), the determination unit 23b recognizes that a safety check action using the side mirror 14 or 15 has not been performed, and causes the warning device 24 to warn the driver with sound (for example, speech) and/or light that the driver did not perform a safety check using the side mirror 14 or 15 (S18). With this arrangement, it is possible to urge the driver to perform a safety check action using the side mirror 14 or 15.

In the case in which the determination unit 23b determines that the driver 30 has performed a safety check using the side mirror 14 on the left side or 15 on the right side (S16: Yes), next, the determination unit 23b determines whether or not the driver 30 performs a direct visual check of the left side or the right side of the vehicle 10 (S19).

In the case of determining that the driver 30 ha not performed a direct visual safety check (S19: No), the determination unit 23b determines whether or not the steering wheel 16 is operated (S20). In the case of determining that the steering wheel 16 is operated (S20: Yes), the determination unit 23b recognizes that a direct visual safety check action has not been performed, and causes the warning device 24 to warn the driver 30 with sound (for example, speech) and/or light that the driver did not perform a direct visual safety check (S21). With this arrangement, it is possible to urge the driver to perform a direct visual safety check action.

After that, the driver 30 proceeds with the left-turn action, the right-turn action, or the lane-changing action, and upon completion of the left turn, right turn, or lane change, the direction indicator 11 on the left side or 12 on the right side stops (S22), and the flow proceeds to S1 illustrated in FIG. 5A.

As described above, it is possible to monitor dangerous driving behaviors such as distracted driving and drowsy driving by the driver 30, without misrecognizing the neglect of safety check actions caused by insufficient experience, lowered attentiveness, or the like of the driver 30 as dangerous driving behaviors such as distracted driving or drowsy driving. The above is also effective in developing habitual safety check actions.

In addition, when making a left turn, a right turn, or a lane change, the driver monitoring device 20 causes the detection unit 23a to analyze the direction (orientation) of the face and/or the line of sight of the driver 30, thereby making it possible for the driver monitoring device 20 to cause the determination unit 23b to determine whether or not safety check actions by checking the rear-view mirror 13, checking the side mirrors 14 and 15, and performing a direct visual check of the sides of the vehicle 10 are neglected. Also, when the determination unit 23b determines that safety check actions are neglected, the driver monitoring device 20 is able to urge the driver 30 to pay attention by causing the warning device 24 to produce a warning.

Also, by urging the driver 30 to perform a safety check action at at least one time from among when turning left or turning right, changing lanes, and starting moving, it is possible no travel safely.

Also, by switching the monitoring purpose between when travelling normally (such as moving forward, with the direction indicators in the off state) and when turning left, turning right, or changing lanes, it is possible to monitor dangerous driving behaviors such as distracted driving and drowsy driving by the driver 30 without misrecognizing safety check actions by the driver 30 as distracted driving.

Also, it is possible to switch back the purpose of driver monitoring from monitoring the presence or absence of safety check actions caused by insufficient experience, lowered attentiveness, and the like of the driver 30 to monitoring of the presence or absence of dangerous driving behaviors such as distracted driving or drowsy driving by the driver 30.

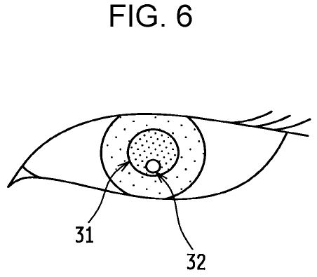

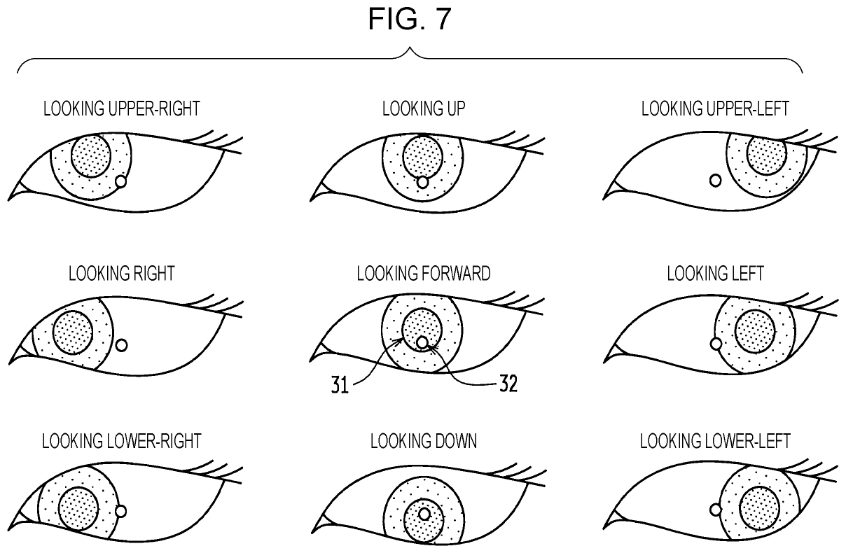

FIG. 6 is an explanatory diagram for explaining a person's pupil 31 and a Purkinje image 32, and FIG. 7 is an explanatory diagram for explaining the positional relationship between the person's pupil 31 and the Purkinje image 32.

The detection unit 23a computes the direction of the line of sight of the driver 30 from the positional relationship between the pupil 31 and the Purkinje image 32 (a reflected image on the surface of the cornea).

As illustrated in FIG. 2, if the light source 22 using near-infrared rays is radiated toward the face of the driver 30 from nearly in front of the driver 30, as illustrated in FIG. 6, the light appears as a reflected image called the Purkinje image 32 on the surface of the cornea. The Purkinje image 32 is reflected by the cornea (eyeball), and thus appears at the same position even if the direction of the line of sight changes. This Purkinje image 32 is used as a reference to compare the positional relationship with the pupil 31, as illustrated in FIG. 7. With this arrangement, the detection unit 23a is able to compute the direction of the line of sight easily.

The determination unit 23b determines the presence or absence of safety check actions according to the direction of the line of sight of the driver 30 computed by the detection unit 23a. Positional relationships between the pupil and the Purkinje image during safety check actions by the driver 30 are recorded in advance in the storage unit 23c of the face recognition system 23. Subsequently, the determination of the presence or absence of a safety check action is executed by comparing the direction of the line of sight while driving to the directions of the line of sight during safety check actions recorded in the storage unit 23c.

### Embodiment 2

In Embodiment 1, the driver monitoring device 20 according to the embodiments is applied to the vehicle 10, but may also be applied to a moving object that is steered or piloted by a person, such as a flight vehicle or a marine vessel. Consequently, the term “driving” herein is a concept that includes not only wheeled vehicles, but also cases of piloting or steering moving objects such as flight vehicles and marine vessels. In such cases, the driver is also referred to as the pilot or helmsman.

### Embodiment 3

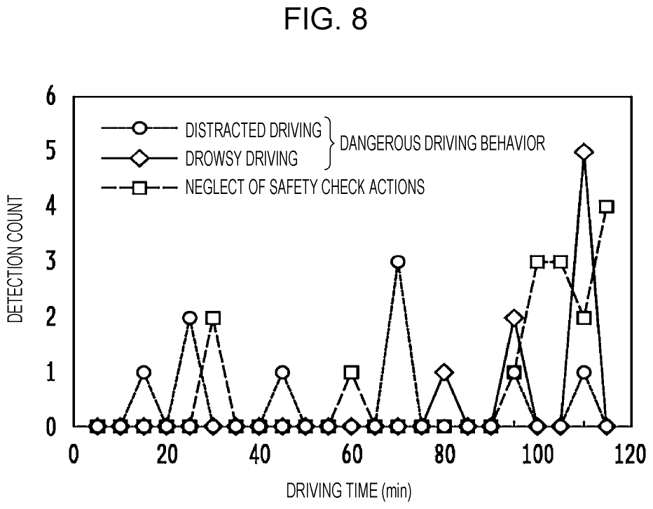

Embodiment 2 according to the present invention will be described while referring to FIGS. 1 and 8.

FIG. 8 is a graph illustrating the change over time in a count of the neglect of safety check actions and a count of dangerous driving behaviors while driving. Note that in the graph illustrated in FIG. 8, distracted driving and drowsy driving are given as examples of dangerous driving behaviors.

The driver monitoring device 20 according to Embodiment 3 is different from the driver monitoring device 20 described in Embodiment 1 and Embodiment 2 in the point of recording determination results to a storage device [specifically, a drive recorder 25 (see FIG. 1)]. With this arrangement, it is possible to check the status while driving and the safe driving skills of the driver oneself.

The driver monitoring device 20 according to Embodiment 3 compares a count of safe driving actions that factor in insufficient experience, lowered attentiveness, and the like of the driver 30 and a count of dangerous driving behaviors such as distracted driving and drowsy driving to a driving time, and as illustrated in FIG. 8, is thereby able to analyze the degree of neglect of safety check actions, the degree of dangerous driving behaviors, and the change in the physical condition (such as the extent fatigue) of the driver while driving, and cause the warning device 24 to urge the driver 30 to take a rest depending on the situation.

With this configuration, use is possible not only when driving or piloting an actual moving object, but also in a driving simulator, a flight simulator, or the like. With this arrangement, an improvement in operating skills and safety check skills with respect to a moving object may be achieved.

The present invention is not limited to the embodiments described above, and may be carried out in a variety of other forms. For this reason, such embodiments are merely illustrative examples in all respects, and should not be interpreted as being limitative. The scope of the present invention is indicated by the scope of the claims, and is not restricted in any way by the text of the description. Furthermore, modifications and alterations belonging to the scope of the claims or their equivalents are all included in the scope of the present invention.

1. A driver monitoring device comprising:
a driver monitoring camera that takes as image of a face of a driver;
a detection unit that detects safety check action information related to a safety check action of the driver on a basis of a face image of the driver captured by the driver monitoring camera; and
a determination unit that determines whether or not the driver is neglecting the safety check action on a basis of the safety check action information detected by the detection unit.

2. The driver monitoring device according to claim 1, further comprising:
a light source that radiates infrared rays toward the face of the driver, wherein
the driver monitoring camera takes an image of the face of the driver irradiated by the infrared rays from the light source.

3. The driver monitoring device according to claim 1, wherein
the safety check action information includes information computed from a direction of the face and/or a direction of a line of sight.

4. The driver monitoring device according to claim 1, wherein
the determination by the determination unit of whether or not the safety check action is neglected is performed at at least one time from among when turning left or turning right, when changing lanes, and when starting moving.

5. The driver monitoring device according to claim 1, wherein
the determination unit determines that the safety check action is neglected in a case in which the safety check action is not performed from a start time of as operation of a direction indicator until a direction of a steering wheel changes by a certain angle or more.

6. The driver monitoring device according to claim 1, wherein
the safety check action includes at least one safety check action from among a safety check action using a rear-view mirror, a safety check action using a side mirror, and a direct visual safety check action.

7. The driver monitoring device according to claim 1, wherein
in a case in which the determination unit determines that the driver is neglecting the safety check action, a warning is issued to the driver.

8. The driver monitoring device according to claim 7, wherein
the warning is issued by sound.

9. The driver monitoring device according to claim 7, wherein
the warning is issued by light.

10. The driver monitoring device according to claim 1, wherein
a purpose of driver monitoring is switched in accordance with an operation of a direction indicator.

11. The driver monitoring device according to claim 1, wherein
while a direction indicator is operating, a warning informing the driver that one is engaged in dangerous driving behavior is not issued.

12. A driver monitoring device comprising:
a driver monitoring camera that takes an image of a face of a driver;
a detection unit that detects dangerous driving behavior information related to a dangerous driving behavior of the driver on a basis of a face image of the driver captured by the driver monitoring camera; and
a determination unit that determines whether or not the driver is engaged in the dangerous driving behavior on a basis of the dangerous driving behavior information detected by the detection unit, wherein
while a direction indicator is operating, a warning informing the driver that one is engaged in dangerous driving behavior is not issued.
